(19) United States
(12) Patent Application Publication
(10) Pub. No.: US 2025/0226620 A1
(43) Pub. Date: Jul. 10, 2025

(54) METHOD AND APPARATUS FOR HANDLING FOREIGN OBJECTS AT CHARGING PORTS

(71) Applicant: Samsung Electronics Co., Ltd., Suwon-si (KR)

(72) Inventors: Choice CHOUDHARY, Noida (IN); Sandeep Singh SPALL, Noida (IN); Priyanka YADAV, Noida (IN)

(21) Appl. No.: 19/091,193

(22) Filed: Mar. 26, 2025

Related U.S. Application Data
(63) Continuation of application No. PCT/KR2023/002075, filed on Feb. 13, 2023.

(30) Foreign Application Priority Data
Oct. 31, 2022 (IN) 202211062040

(51) Int. Cl. H01R 13/66; G01N 27/04; G01N 27/06

(52) U.S. Cl. CPC H01R 13/6683; G01N 27/043; G01N 27/06

(57) ABSTRACT

An electronic device for handling a foreign object at a charging port of the electronic device is provided. The method includes detecting the presence of the foreign object at the charging port of the electronic device, based on an impedance among two or more pins of the charging port, identifying at least one property of the foreign object based on a relationship of the impedance among the two or more pins of the charging port, wherein the at least one property includes at least one of a type of the foreign object and a direction of movement of the foreign object in the charging port, and generating, based on the at least one property of the foreign object, at least one of a sound and a vibration to eliminate the foreign object from the charging port.

### CROSS-REFERENCE TO RELATED APPLICATION(S)

This application is a continuation application, claiming priority under § 365 (c), of an International application No. PCT/KR2023/002075, filed on Feb. 13, 2023, which is based on and claims the benefit of an Indian Patent Application number 202211062040, filed on Oct. 31, 2022, in the Indian Patent Office, the disclosure of which is incorporated by reference herein in its entirety.

### BACKGROUND

### 1. Field

The disclosure relates to foreign objects (e.g., moisture, dust, etc.) at charging ports of electronic devices. More particularly, the disclosure relates to systems and methods for detecting the presence of foreign objects at charging ports of electronic devices and handling the same.

### 2. Description of Related Art

Portable electronic devices, such as mobile phones, may be exposed to moisture or dust (termed here as foreign objects) during their day-to-day usage. Such devices may be exposed to water, construction dust, sweat, or rain. Most of these devices include a receptacle connector or a charging port that has an opening at an exterior of the device in which multiple contacts reside. A corresponding plug connector may be inserted into the receptacle connector port or the charging port to charge the internal battery of the device, or for transfer data to/from the device, among various other functions. When such foreign objects are introduced into the connector, some pins on the connector may be short-circuited, corroded, or broken. When the electronic device is charged through the cable while the contacts within the connector port are exposed to moisture/dust, electric current may flow between some of the pins on the connector resulting in excessive power consumption by the electronic device, which may cause damage to the electronic device.

Some electronic devices include software to detect moisture at receptacle ports and to indicate stopping usage of receptacle ports in the electronic devices till the foreign object is removed. Further, the moisture detection algorithm may stop the device from charging automatically as soon as it detects moisture in the charging port or the universal serial bus (USB) cable. Conventionally, to get rid of such foreign objects, users use a soft dry cloth to gently wipe their electronic devices detection of such foreign objects and shake it while keeping the charging port down. Then place it in the open air or under the ceiling fan for some time so that the moisture evaporates. Additional conventional solutions include stuffing the electronic device in a bag of dry rice or in a jar of silica for a specified time. Some users use hairdryers to mildly blow hot air at slow or moderate speed into the receptacle ports to ensure that the moisture/liquid type foreign object dries up.

Such conventional solutions have their own limitations, as these solutions are not intelligent, and unable to inform how long the device may not be accessible. Also, sometimes, such conventional approaches can lead to hardware damage in electronic devices. Further, such conventional solutions may sometimes also provide false positive moisture detection alerts.

Accordingly, there is a need for a system and method which may handle the detection of foreign objects in a better manner. Additionally, there is a need for a system and method for automatically getting rid of foreign objects with minimal manual intervention. There is also a need for a system and method to determine the exact time of how long the device shall not be available for usage.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide systems and methods for detecting the presence of foreign objects at charging ports of electronic devices and handling the same.

Additional aspects will be set forth in part in the description which follows and, in part, will be apparent from the description, or may be learned by practice of the presented embodiments.

In accordance with an aspect of the disclosure, a method for handling a foreign object at a charging port of an electronic device is provided. The method includes detecting a presence of the foreign object at the charging port of the electronic device, based on an impedance among two or more pins of the charging port, identifying at least one property of the foreign object based on a relationship of the impedance among the two or more pins of the charging port, wherein the at least one property comprises at least one of a type of the foreign object and a direction of movement of the foreign object in the charging port, and generating, based on the at least one property of the foreign object, at least one of a sound and a vibration to eliminate the foreign object from the charging port.

In accordance with another aspect of the disclosure, an electronic device for handling a foreign object at a charging port of the electronic device is provided. The electronic device includes memory storing one or more computer programs, and one or more processors communicatively coupled to the memory, wherein the one or more computer programs include computer-executable instructions that, when executed by the one or more processors individually or collectively, cause the electronic device to detect a presence of the foreign object at the charging port of the electronic device, based on an impedance among two or more pins of the charging port, identify at least one property of the foreign object based on a relationship of the impedance among the two or more pins of the charging port, wherein the at least one property comprises at least one of a type of the foreign object and a direction of movement of the foreign object in the charging port, and generate, based on the at least one property of the foreign object, at least one of a sound and a vibration to eliminate the foreign object from the charging port.

In accordance with another aspect of the disclosure, one or more non-transitory computer-readable storage media storing one or more computer programs including computer-executable instructions that, when executed by one or more processors of an electronic device individually or collectively, cause the electronic device to perform operations is provided. The operations includes detecting a presence of the foreign object at the charging port of the electronic device, based on an impedance among two or more pins of the charging port, identifying at least one property of the foreign object based on a relationship of the impedance among the two or more pins of the charging port, wherein the at least one property comprises at least one of a type of the foreign object and a direction of movement of the foreign object in the charging port, and generating, based on the at least one property of the foreign object, at least one of a sound and a vibration to eliminate the foreign object from the charging port.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a type-C connector/charging port of an electronic device, which may be used for moisture detection/eradication, according to an embodiment of the disclosure;

FIG. 2 illustrates a schematic block diagram of a system for handling of a foreign object at a connector/receptacle/charging port of a user device, according to an embodiment of the disclosure;

FIG. 3 illustrates another schematic block diagram of a system depicting one or more functions associated with a handling of the foreign object at a connector, according to an embodiment of the disclosure;

FIG. 4 illustrates a schematic block diagram of modules of a system for handling of a foreign object, according to an embodiment of the disclosure;

FIG. 5 illustrates foreign objects classification based on impedance ranges of various pins of a connector, according to an embodiment of the disclosure;

FIG. 6 illustrates a rate of change of impedance between two pins corresponding to an impedance between two other pins in case of a specific foreign object (e.g., water), according to an embodiment of the disclosure;

FIGS. 7A and 7B illustrate a training of an artificial intelligence (AI) model to classify foreign object(s), according to various embodiments of the disclosure;

FIGS. 8A and 8B illustrate a determination and a flowchart, respectively, associated with a foreign object movement identification module, according to various embodiments of the disclosure;

FIG. 9A illustrates a USB pin state with impedance at different times t1, t2, and tn, according to an embodiment of the disclosure;

FIG. 9B illustrates a rate of change of impedance at every pin of a connector, according to an embodiment of the disclosure;

FIG. 10 illustrates a sample dataset for sound-based eradication of a foreign object, according to an embodiment of the disclosure;

FIG. 11 illustrates a flowchart for the eradication of a foreign object using sound, according to an embodiment of the disclosure;

FIG. 12 illustrates a set of vibration motor compensation (intensity) for an electronic device, according to an embodiment of the disclosure;

FIG. 13 illustrates a schematic of a vibration intensity on different predefined distances, according to an embodiment of the disclosure;

FIG. 14 illustrates a flowchart for an eradication of a foreign object using vibration, according to an embodiment of the disclosure;

FIG. 15 illustrates a sample dataset for a determination of an eradication meter module, according to an embodiment of the disclosure;

FIG. 16 illustrates a sample dataset for recommendations to handle foreign objects by a recommendation module, according to an embodiment of the disclosure;

FIG. 17 illustrates a process flow depicting a method 1700 to provide one or more recommendations by a recommendation module, according to an embodiment of the disclosure;

FIG. 18 illustrates a process flow depicting a method for handling of a foreign object, according to an embodiment of the disclosure;

FIG. 19 illustrates another process flow depicting a method for handling of the foreign object, according to an embodiment of the disclosure; and

FIGS. 20, 21, and 22 illustrate various use cases for handling of a foreign object, according to various embodiments of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The terms “receptacle”, “receptacle connector”, receptacle connector port”, “connector”, “charging port”, and their inherently implied variations are being used interchangeably throughout this disclosure.

The disclosure is directed towards a method and system for identifying foreign particles and associated properties on connector/charging ports as soon as they attack, which is not limited to the pin assigned for detection as foreign object. This may be performed using resistance and current analysis (i.e., impedance analysis) across all pins in relation to pins defined for detection. This is required for knowing path flow and deviation in that of foreign particles on the interface surface in every direction. Embodiments are directed towards detecting the presence of moisture in the USB charging port of a smart-phone/electronic device and identifying the properties of the foreign object (e.g., moisture content), such as the type of moisture content and the direction in which it attacks the connector/port using resistance and current analysis across all pins of the connector/port (e.g., a USB charging port).

Some embodiments of the disclosure are directed towards generating a test signal based on the movement of the foreign particle on the surface for the test signal. The amplitude and frequency of the test signal may be modulated also considering processor temperature to deflect and as well as monitoring new path/deviation in old one so that compensation can be applied to avoid any new current/resistance values that are eligible to generate moisture detection alerts. Further, the embodiments are directed towards eliminating the presence of moisture in the USB charging port by producing sound and vibrations based on the movement of moisture. Other embodiments are directed towards providing the user with an intuitive response pertaining to the time required to eradicate/evaporate the foreign object/moisture present in the USB charging port based on over-current variations in various zones on the surface, moisture on the port, environment condition, and present device condition.

Still other embodiments of the disclosure are directed towards predicting the time required to completely eradicate the foreign object on the basis of over-current variations in various zones on the surface, moisture on the port, environment condition, and current device condition.

According to one or more embodiments, a recommendation may be provided for positioning the device in the current environment so that moisture on the USB port surface can be minimized or prevented. More specifically, embodiments of the disclosure are directed towards an artificial intelligence (AI) based recommendation module which is configured to provide multiple recommendations to the user such as a change in the position/orientation of the device, for minimizing or preventing the presence of moisture in the USB charging port of the device.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

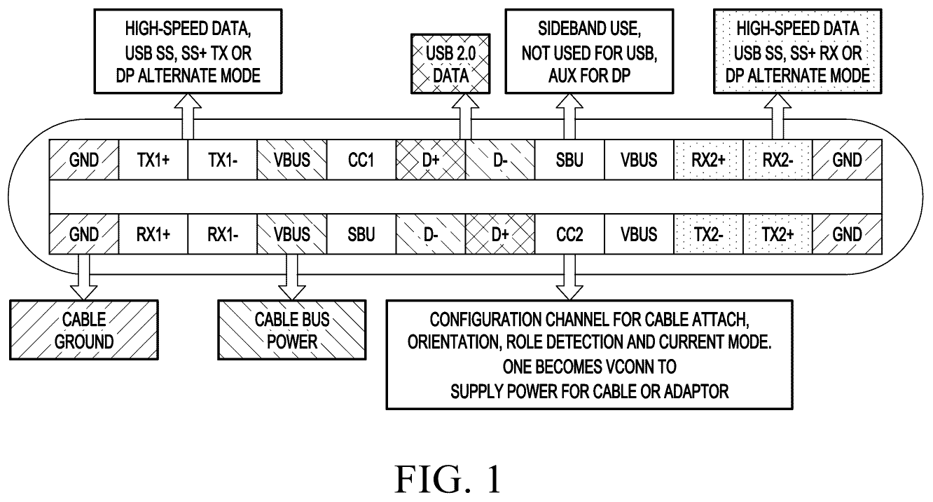

FIG. 1 illustrates a type-C connector/charging port of an electronic device, which may be used for moisture detection/eradication, according to an embodiment of the disclosure.

As widely known, the USB Type-C receptacle port may support various functions, such as device charging, audio support, fast data transfer, high definition multimedia interface (HDMI), and Mobile High Definition (MHL). Additionally, as depicted, the USB Type-C receptacle port may include a total of 24 pins, with 12 pins on each side due to the interchangeability of C-type USB. The current and resistance may flow between different sets of pins to execute accessory functionality. Some embodiments of the disclosure are directed towards using one or more combinations of pins for detecting any moisture, or conductive debris/particles at the connector/port (e.g., USB Type-C receptacle).

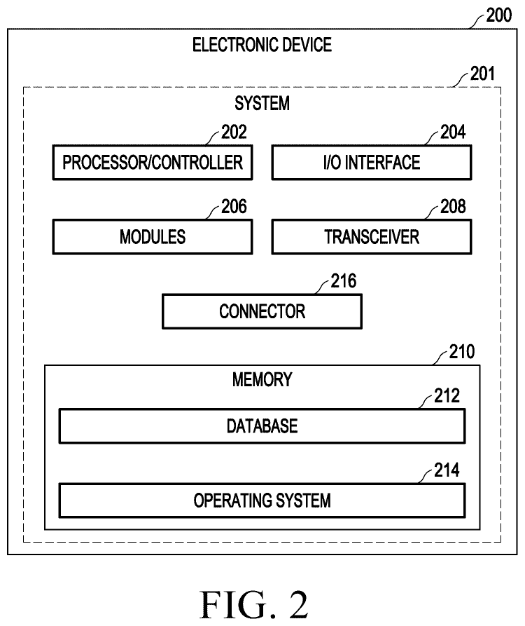

FIG. 2 illustrates a schematic block diagram of a system 201 for the handling of a foreign object at a connector/receptacle/charging port of a user device 200, according to an embodiment of the disclosure.

In an embodiment, a system 201 may be included within an electronic/user device 200. In another embodiment, the system 201, in part or as a whole, may be configured to operate as a standalone device or a system based on a server/cloud architecture communicably coupled to the electronic device 200.

In some embodiments, the electronic device 200 may be a USB device capable of communicating with an external electronic device via a USB interface. However, the electronic device 200 is not limited to a USB device and may be any electronic device capable of communicating with the external electronic device via an interface according to a communication standard. The electronic device 200 may be any electronic device including an audio jack terminal such as an ear jack terminal.

The connector 216 may be a receptacle or a plug or a charging port, as discussed throughout the disclosure, where the foreign object is detected. In some example embodiments, the connector 216 may be connected to an external cable and may perform communication between the external device and the electronic device 200 via the cable. Examples of the electronic device 200 may include, but are not limited to, a mobile phone, a smart watch, a laptop computer, a desktop computer, a Personal Computer (PC), a notebook, a tablet, and or any other device which includes a connector/receptacle port to execute one or more functions, such as, but not limited to, charging and data transfer. Some examples of connector/receptacle ports may include but are not limited to, a USB type-C receptacle port. While the embodiments of the disclosure are generally directed towards the receptacle/connector port associated with the charging of electronic device 200, it may be understood that some or all of the features of the disclosure may be applied to all other similar ports in electronic devices for handling of any foreign objects, as discussed herein.

The system 201 may be configured to detect the presence of foreign objects (e.g., dust, moisture) in the connector 216 (e.g., a USB charging port) of the electronic device 200 and identify the properties of the moisture content, such as the type of moisture content and the direction in which it attacks the connector using resistance and current analysis across all pins of the connector. The system 201 may be configured to eliminate the presence of a foreign object(s) in the connector 216 by producing sound and vibrations based on the movement of moisture. Additionally, the system 201 may be configured to provide the user with an intuitive response pertaining to the time required to eradicate the foreign object(s) (e.g., moisture) present in the connector 216 based on over-current variations in various zones on the surface, moisture on the port, environment condition, and present device condition. Furthermore, the system 201 may be configured to provide one or more recommendations to the user such as a change in the position/orientation of the electronic device 200, for minimizing or preventing the presence of moisture in the connector 216 (e.g., a USB charging port) of the electronic device 200.

In an embodiment, the system 201 may include a processor/controller 202, an Input/Output (I/O) interface 204, one or more modules 206, a transceiver 208, memory 210, and a connector 216.

In another embodiment, the processor/controller 202 may be operatively coupled to each of the I/O interface 204, the modules 206, the transceiver 208, and the memory 210. In one embodiment, the processor/controller 202 may include at least one data processor for executing processes in Virtual Storage Area Network. The processor/controller 202 may include specialized processing units such as integrated system (bus) controllers, memory management control units, floating point units, graphics processing units, digital signal processing units, etc. In one embodiment, the processor/controller 202 may include a central processing unit (CPU), a graphics processing unit (GPU), or both. The processor/controller 202 may be one or more general processors, digital signal processors, application-specific integrated circuits, field-programmable gate arrays, servers, networks, digital circuits, analog circuits, combinations thereof, or other now-known or later-developed devices for analyzing and processing data. The processor/controller 202 may execute a software program, such as code generated manually (i.e., programmed) to perform the desired operation.

The processor/controller 202 may be disposed in communication with one or more input/output (I/O) devices via the I/O interface 204. The I/O interface 204 may employ communication code-division multiple access (CDMA), high-speed packet access (HSPA+), global system for mobile communications (GSM), long-term evolution (LTE), worldwide interoperability for microwave access (WiMax), or the like, etc.

Using the I/O interface 204, the system 201 may communicate with one or more I/O devices. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor/controller 202 may be disposed in communication with a communication network via a network interface. In another embodiment, the network interface may be the I/O interface 204. The network interface may connect to the communication network to enable connection of the system 201 with the outside environment and/or device/system. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network and the voice assistant device of the system 201 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

In an embodiment, the processor/controller 202 may be configured to perform one or more process/method steps, as discussed throughout this disclosure, to handle the foreign object at the connector 216 of the electronic device 200. In some embodiments where one or more components of the system 201 (e.g., modules 206) are implemented as a standalone entity at a server/cloud architecture, the information associated with the foreign object may be received from the electronic device 200. For example, one or more modules 206 (for example, AI/machine learning (ML) based modules) may be included in a server/cloud architecture and execute process/method steps as discussed herein from the architecture. The processor/controller 202 may execute a set of instructions to handle the foreign object at the connector 216 of the electronic device 200. The processor/controller 202 may implement various techniques such as, but not limited to, Natural Language Processing (NLP), data extraction, Artificial Intelligence (AI), and so forth to achieve the desired objective.

In various embodiments, the memory 210 may be communicatively coupled to the at least one processor/controller 202. The memory 210 may be configured to store data and instructions executable by the at least one processor/controller 202. In one embodiment, the memory 210 may communicate via a bus within the system 201. The memory 210 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 210 may include a cache or random-access memory for the processor/controller 202. In alternative examples, the memory 210 is separate from the processor/controller 202, such as a cache memory of a processor, the system memory, or other memory. The memory 210 may be an external storage device or database for storing data. The memory 210 may be, for example, operable to store instructions executable by the processor/controller 202. The functions, acts, or tasks illustrated in the figures or described may be performed by the programmed processor/controller 202 for executing the instructions stored in the memory 210. The functions, acts, or tasks are independent of the particular type of instruction set, storage media, processor, or processing strategy and may be performed by software, hardware, integrated circuits, firmware, micro-code, and the like, operating alone or in combination. Processing strategies may include multiprocessing, multitasking, parallel processing, and the like.

In some embodiments, the modules 206 may be included within the memory 210. The memory 210 may further include a database 212 to store data. The one or more modules 206 may include a set of instructions that may be executed to cause the system 201 to perform any one or more of the methods/processes disclosed herein. The one or more modules 206 may be configured to perform the steps of the disclosure using the data stored in the database 212, to handle the foreign object at the connector 216 of the electronic device 200, as discussed herein. In an embodiment, each of the one or more modules 206 may be a hardware unit, which may be outside the memory 210. The memory 210 may include an operating system 214 for performing one or more tasks of the system 201, as performed by a generic operating system in the communications domain. The transceiver 208 may be configured to receive and/or transmit signals to and from the electronic device 200 associated with the user. In one embodiment, the database 212 may be configured to store the information as required by the one or more modules 206 and the processor/controller 202 to handle the foreign object(s) at the connector 216 of the electronic device 200.

In an embodiment, the I/O interface 204 may enable input and output to and from the system 201 using suitable devices such as, but not limited to, a display, keyboard, mouse, touch screen, microphone, speaker, and so forth.

The disclosure contemplates a computer-readable medium that includes instructions or receives and executes instructions responsive to a propagated signal. The instructions may be transmitted or received over the network via a communication port or interface or using a bus (not shown) at the electronic device 200. The communication port or interface may be a part of the processor/controller 202 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection, or may be established wirelessly. The additional connections with other components of the system 201 may be physical or may be established wirelessly. The network may alternatively be directly connected to the bus. For the sake of brevity, the architecture and standard operations of the operating system 214, the memory 210, the database 212, the processor/controller 202, the transceiver 208, and the I/O interface 204 are not discussed in detail.

At least one of the plurality of modules 206 may be implemented through an artificial intelligence (AI) model. A function associated with AI may be performed through the non-volatile memory, the volatile memory, and the processor 202. The processor/controller 202 may include one or a plurality of processors/controllers. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors/controllers 202 control, for example, the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of the desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through the calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction related to the handling of the foreign object(s). Examples of learning techniques include, but are not limited to, supervised learning, unsupervised learning, semi-supervised learning, or reinforcement learning.

According to an embodiment, in a method of an electronic device, a method for handling the foreign object(s) at a connector of the electronic device may use an artificial intelligence model to recommend/execute the plurality of instructions. The processor may perform a pre-processing operation on the data to convert it into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may, for example, include a plurality of neural network layers. Each of the plurality of neural network layers includes a plurality of weight values and performs neural network computation by computation between a result of computation by a previous layer and the plurality of weight values.

Reasoning prediction is a technique of logically reasoning and predicting by determining information and includes, e.g., knowledge-based reasoning, optimization prediction, preference-based planning, or recommendation.

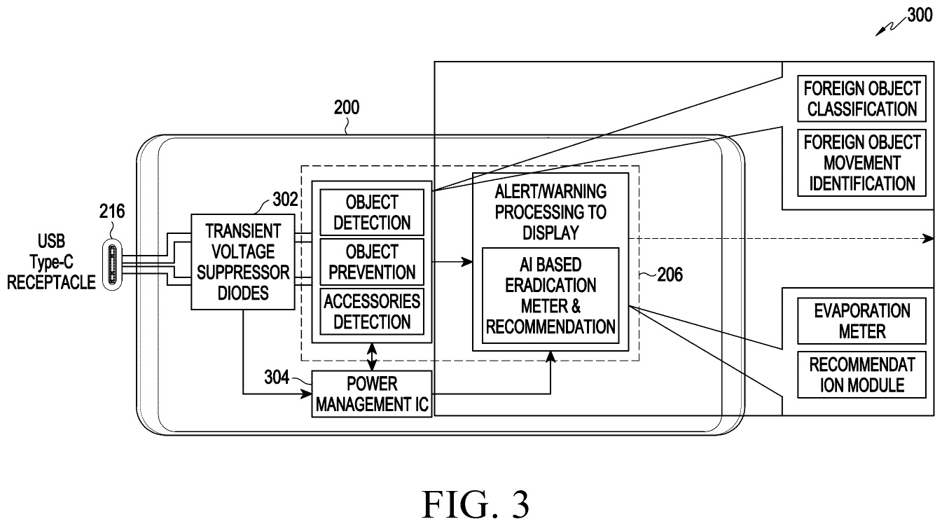

FIG. 3 illustrates another schematic block diagram 300 of a system 201 depicting one or more functions associated with handling of a foreign object at a connector, according to an embodiment of the disclosure.

Referring to FIG. 3, a USB type-C receptacle is illustrated as a connector 216 for an electronic device 200. As depicted, the electronic device 200 may further include a transient voltage suppressor diodes 302 and a power management integrated circuit (IC) 304. The functions of transient voltage suppressor diodes and the power management integrated circuit are well known, and hence, these are not explained in detailed here for the sake of brevity. Further, the one or more modules 206 may include modules to provide functions associated with object detection, object prevention, accessories detection, object eradication, and recommendations associated with foreign objects. The accessories detection (e.g., detection of earphone, charger, etc.) may be performed based on current and resistance analysis (i.e., impedance analysis) on different pins of the USB port.

The object detection function may include detecting the presence of foreign object(s) (e.g., moisture, dust) in the connector (e.g., a USB charging port) of the electronic device 200 and identifying one or more properties of the foreign object (e.g., moisture content) such as type of foreign object and the direction in which the foreign object attacks the connector using resistance and current analysis across all pins of the USB charging port. In an embodiment, the foreign object may be located at any location inside the charging port. For instance, the foreign object may be located at the pins (i.e., in touch with the pins) of the charging port.

The object prevention function may include eliminating the presence of moisture in the USB charging port by producing sound and/or vibrations based on the movement of the foreign object at the connector 216. The AI-based eradication function may include providing the user with an intuitive response pertaining to the time required to eradicate/evaporate the foreign object/moisture present in the connector 216 (i.e., USB charging port) based on one or more of over-current variations in various zones on surface, foreign object on the port, environment condition, and present electronic device's condition. Further, the AI-based recommendation function may include providing multiple recommendations to the user such as a change in the position/orientation of the device, for minimizing or preventing the presence of a foreign object in the USB charging port or connector 216 of the electronic device 200.

As one example, upon detection of a foreign object (e.g., moisture) in the connector 216 of the electronic device 200, a warning indicating “Do Not Connect Cable” may be displayed on a user interface of the electronic device 200. Further, the moisture prevention may be activated for faster utilization of the connector/charging port. Additionally, the electronic device 200 may display the time for which the connector 216 may be unavailable. For example, the electronic device 200 may display “in current device position, the connector port will be available for use in 30 minutes”. Additionally, a recommendation to expedite the process of eliminating the moisture may be displayed, such as “rotate device 30 degrees left for use in 15 minutes.” The functions discussed herein are explained in detail throughout this disclosure along with a separate process flow for executing each of the aforesaid functions.

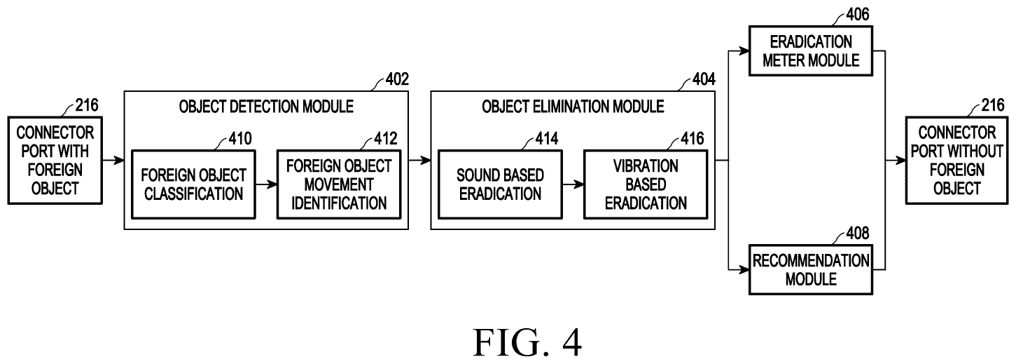

FIG. 4 illustrates a schematic block diagram of modules 206 of a system 201 for handling of a foreign object, according to an embodiment of the disclosure.

The one or more modules 206 may include an object detection module 402, an object elimination module 404, an eradication meter module 406, and a recommendation module 408. The object elimination module 404 includes a sound based eradication module 414 and a vibration based eradication module 416.

In an embodiment, the object detection module 402 may be configured to detect a foreign object (e.g., moisture) and one or more properties associated with the foreign object, such as but not limited to, a type of the foreign object and a direction of movement of the foreign object as soon as the foreign object attacks the connector (e.g., USB port) using one or more characteristics of the USB pins' and resistance between different pins. The object detection module 402 may further include a foreign object classification module 410 and a foreign object movement identification module 412.

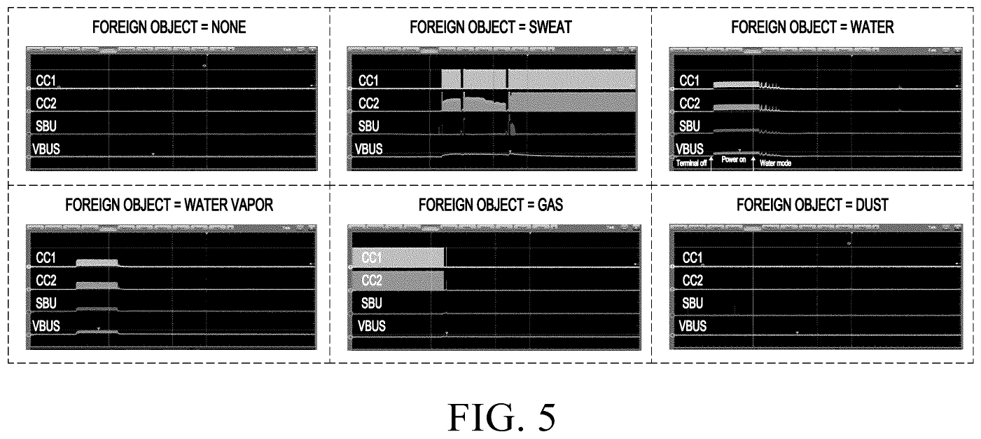

The foreign object classification module 410 may be configured to detect the presence of the foreign object at the charging port of the user device, based on an impedance among two or more pins of the connector/charging port. Further, the foreign object classification module 410 may be configured to classify a type of the detected foreign object based on a relationship of the impedance among the two or more pins. The foreign object classification module 410 and foreign object movement identification module 412 are further discussed in detail in conjunction with FIGS. 5, 6, 7A, 7B, 8A, 8B, 9A, and 9B.

FIG. 5 illustrates a foreign object classification based on impedance ranges of various pins of the connector, according to an embodiment of the disclosure.

In an embodiment, the type of the detected object may include one of water, sweat, vapour, gas, and dust particles. An illustration of detection and classification of the foreign object at the connector is provided in Table 1 below:

TABLE 1

| Power | | CC1 | CC2 | SBU1 | SBU2 | | | Foreign |
|---|---|---|---|---|---|---|---|---|
| State | VBUS | (Kohm) | (Kohm) | (Kohm) | (Kohm) | TX | RX | Object |
| Turned | 0 | 78 | 70 | 290 | 154 | 72 | 3 | Water |
| On | | | | | | | | |
| Turned | 0 | 65 | 59 | 109 | 90 | 58 | 4 | Vapor |
| On | | | | | | | | |
| Turned | 1 | 53 | 55 | 103 | 157 | 68 | 2 | Sweat |
| Off | | | | | | | | |
| Turned | 0 | 42 | 47 | 129 | 105 | 60 | 3 | Sweat |
| On | | | | | | | | |
| Turned | 1 | 26 | 24 | 95 | 68 | 37 | 4 | Gas |
| Off | | | | | | | | |
| Turned | 1 | 74 | 68 | 248 | 137 | 62 | 2 | Sweat |
| On | | | | | | | | |
| Turned | 0 | 68 | 45 | 152 | 118 | 53 | 2 | Water |
| On | | | | | | | | |

It is noted that the electronic conductance at the pins (e.g., VBUS, CC1, CC2, SBU1, SBU2, TX, and RX pins) of the connector 216 varies depending upon the nature of the foreign object. Electrical conductance, i.e., the impedance of the above objects may be in a specified order as mentioned below:
Sweat>Water>Water vapor>Gas>Dust

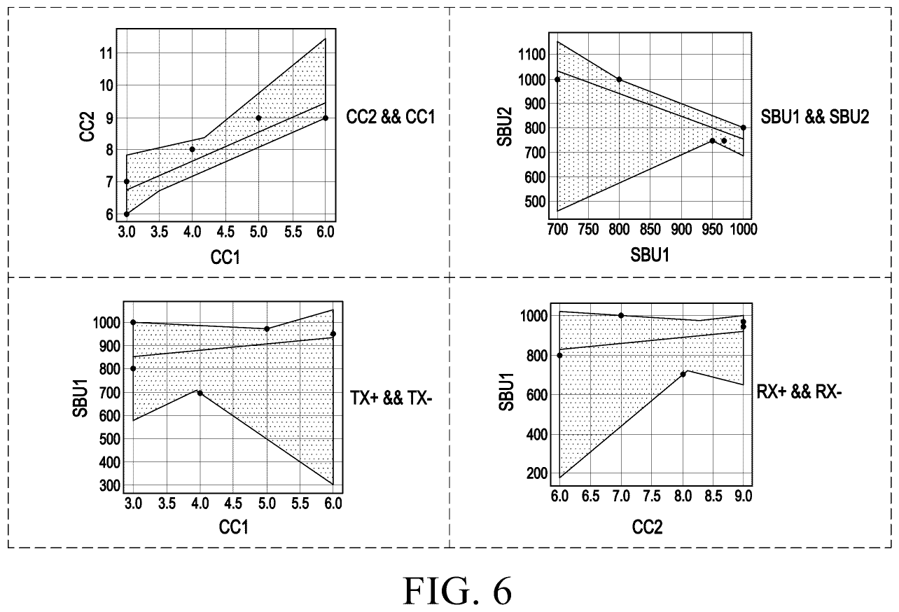

FIG. 6 illustrates a rate of change of impedance between two pins corresponding to the impedance between two other pins in case of a specific foreign object (e.g., water), according to an embodiment of the disclosure.

According to an embodiment, the object detection module 402 or specifically, the foreign object classification module 410 may include a trained machine learning (ML)/AI based model for classifying the foreign object, where the ML model identifies the relationship of impedance between different set of pins of the connector 216 depending upon the type of foreign object. By analyzing the rate of change of impedance among two pins corresponding to two different sets of pins may classify the foreign particle.

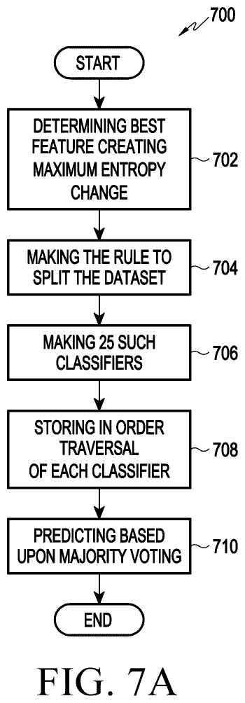

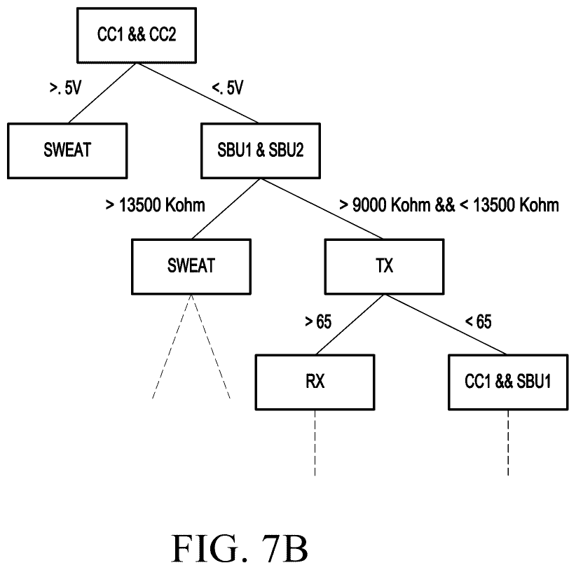

FIGS. 7A and 7B illustrate the training of the AI model to classify the foreign object(s), according to various embodiments of the disclosure.

Referring to FIG. 7A, one or more pre-defined features may include the impedance of one or more pins but are not limited to, CC1 impedance, CC2 impedance, SBU1 impedance, SBU2 impedance, VBUS impedance, TX impedance, and RX impedance. Further, one or more additional features may be extracted for a combination of pins of the connector including, but not limited to, CC1-CC2 impedance, SBU1-SBU2 impedance, TX+−TX impedance, and RX+−RX impedance. Based on the features associated with pre-defined features and the extracted features, the dataset may be trained using an approach (e.g., random forest) with 25 classifiers with a depth of each classifier being 6. As it may be understood to a person skilled in the art, TX and RX are associated with upload and download speed. For instance, when a user is connected using earphones, TX/RX would imply a speed of transfer of content from the USB port of the mobile device to the earphone pins.

Further, a decision tree-based approach may be implemented for classifying foreign objects wherein a total of 25 rule-based classifiers are used to learn the developed dataset, as discussed above. The outputs of these 25 trees may then be used to predict the correct output. As depicted, the method 700 may include operations 702-710 to classify the foreign object. Specifically, as the charging ports are in an active mode, the foreign object may be detected using the below method using a trigger. In one embodiment, the trigger may be detected based on interrupt and polling.

At operation 702, the method 700 may include determining the best feature creating maximum entropy change. The best feature may be determined based on:

$$Gini = 1 - {\sum }_{j = 1}^{c} {p}_{j}^{2}$$

$$Entropy = {\sum }_{j = 1}^{c} {p}_{j} log {p}_{j}$$

Impurity of a dataset calculation: Imp=a²+b² (a→#of 0s) (b→#of 1s). After calculating the impurity for every column and every possible value in the respective column, the one with the maximum score is chosen as a splitting rule at a node. At operation 704, the method 700 comprises determining a rule to split the dataset. Further, at operation 706, the method 700 comprises making 25 such classifiers, as discussed above. At operation 708, the method 700 comprises storing in order traversal of each classifier. At operation 710, the method 700 comprises predicting based on majority voting.

FIG. 7B illustrates a rule-based classifier example to classify a foreign object, according to an embodiment of the disclosure.

Here, an example of one of the decision trees out of 25 decision trees is depicted. As is widely known, the most important feature is located at the top of the decision tree. Since, the process of decision trees for classification is generally well-known, this is not discussed in detail for the sake of brevity.

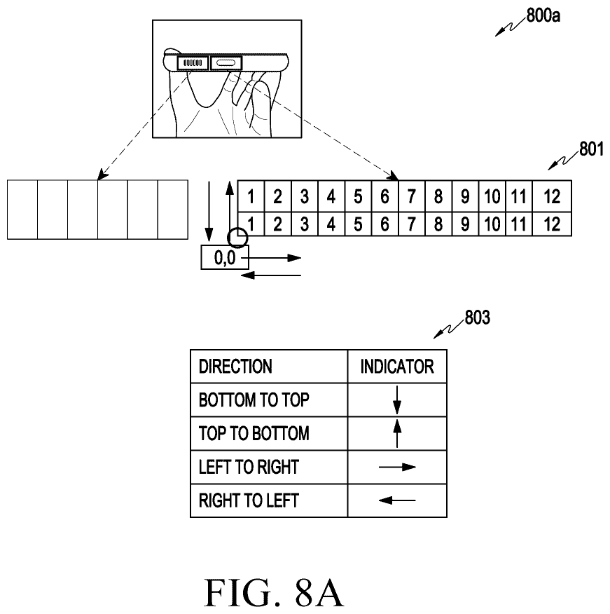

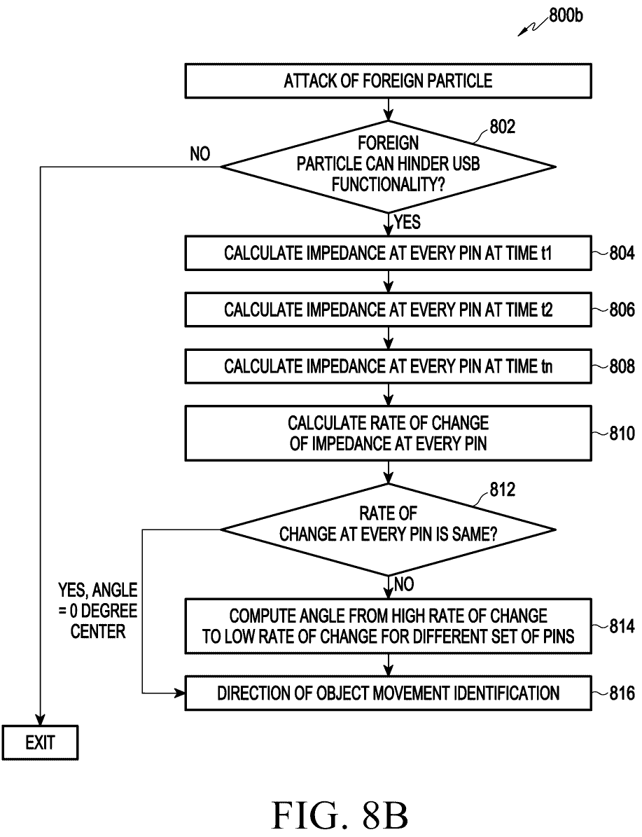

FIGS. 8A and 8B illustrate a determination and a flowchart, respectively, associated with a foreign object movement identification module 412, according to various embodiments of the disclosure.

Referring to FIG. 8A, a determination 800a associated with a foreign object movement identification module 412 includes a set of 24 pins 801 of a C-type connector or charging port are depicted as 1-12 in top row and 1-12 in bottom row. The foreign object movement identification module 412 may be configured to determine a direction of movement 803 of the foreign object from one pin to another. As depicted, the set of directions may include, but are not limited to, bottom to top, top to bottom, left to right, and right to left. These directions are indicated using indicators/arrows as depicted in 803. In an embodiment, the angle from left to right may be considered as +ve (if the speaker is left to the connector/USB port) and right to left will be considered as −ve and vice versa.

Referring to FIG. 8B, a flowchart illustrating a method 800b is depicted to determine the direction of movement of the foreign object. As depicted, at operation 802, the method comprises determining whether a foreign object may hinder the functionality of the connector or charging port of the electronic device. In an embodiment, the determination whether the foreign object may hinder functionality of the connector may be based on a current and resistance analysis of the charging port. If the value output of a current and resistance analysis is more than a predefined threshold, then it may be concluded that the foreign object may hinder the functionality of the connector. If the functionality may be hindered, at operations 804, 804, 806, and 808, the impedance at each of the 24 pins of the connector may be determined at different pre-specified timestamps, such as t1, t2, and tn. Further, at operation 810, the method comprises determining a rate of change of impedance at every pin based on the impedance determined at timestamps, i.e., t1, t2, and tn.

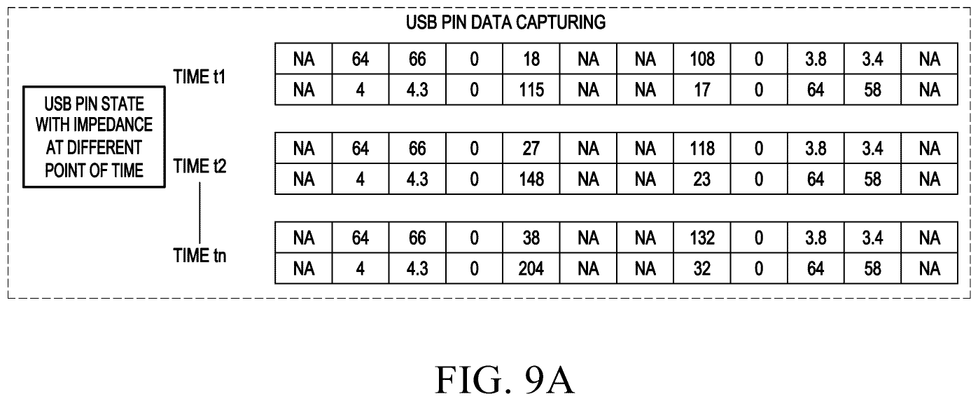

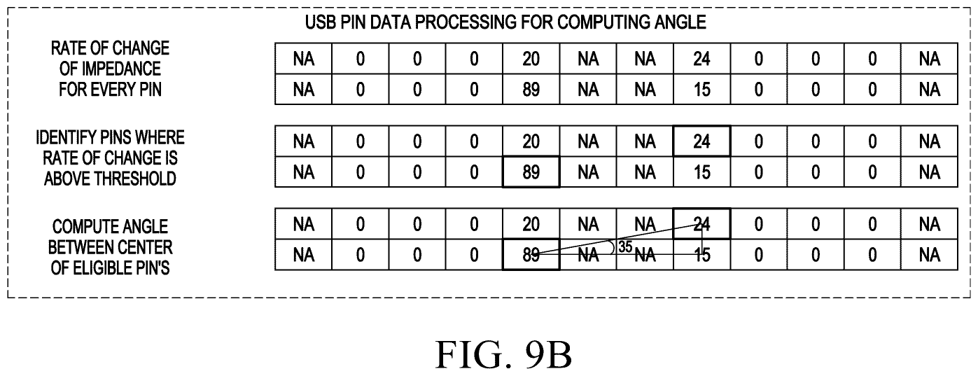

FIG. 9A illustrates a USB pin state with impedance at different timestamps, t1, t2, and tn according to an embodiment of the disclosure.

Referring back to FIG. 8A, at operation 812, the method comprises determining whether the rate of change of impedance is the same as at every pin.

FIG. 9B illustrates a rate of change of impedance at every pin of the connector according to an embodiment of the disclosure.

Referring back to FIG. 8B, if it is determined at operation 812 that the rate of change of impedance is the same at every pin, the method 800b moves to operation 816 where a direction of movement of the object is identified. At operation 814, the method 800b may include computing the angle from a high rate of change to a low rate of change for a different set of pins. In an embodiment, a few pins may be identified for which the rate of change of the impedance is higher than a predefined threshold. Subsequently, an angle may be computed between the identified set of pins. This is further illustrated in detail in FIG. 9B.

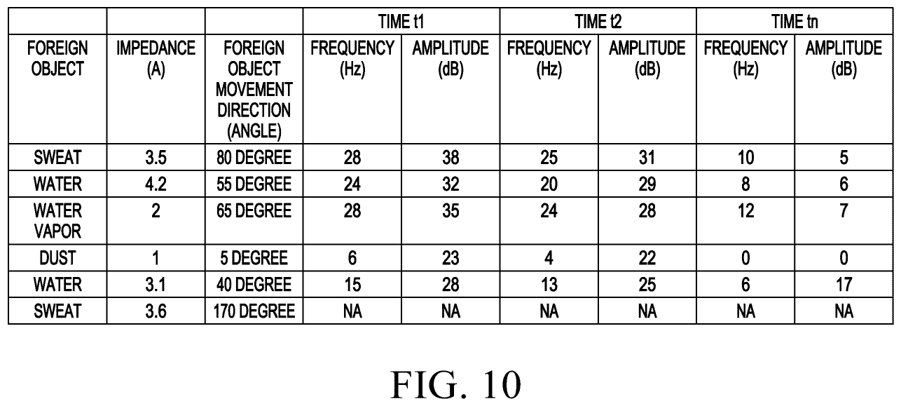

Referring back to FIG. 4, in an embodiment, the object elimination module 404 may be configured to generate different kinds of test signals, i.e., sound and/or vibration signals, which vary in amplitude, frequency, and/or wavelength based on various properties associated with the foreign object, the connector/USB port, and condition of the electronic device. In an embodiment, the condition of the electronic device may include temperature and/or battery level of the electronic device. Further, the elimination of the foreign object may include a partial or a complete removal of the foreign object from the inside area of the charging port. A partial removal may mean removing a part of the foreign object from the pins of the charging port, and/or displacing the foreign object from its original location of detection to another location at the charging port. The functions associated with the object elimination module 404 is further discussed in detail in conjunction with FIGS. 10 to 14.

FIG. 10 illustrates a sample dataset for sound based eradication of a foreign object, according to an embodiment of the disclosure.

As depicted, based on the type of foreign object, an impedance, and the angle of movement of the foreign object; the frequency and amplitude for eradication may be determined at different times/timestamps (e.g., t1, t2, and tn). These specified time durations and timestamps may be predefined for each type of foreign object, impedance, and foreign object's movement direction. This is the frequency and amplitude of the sound to be generated by a speaker of the electronic device to eliminate the foreign object from the connector/charging port.

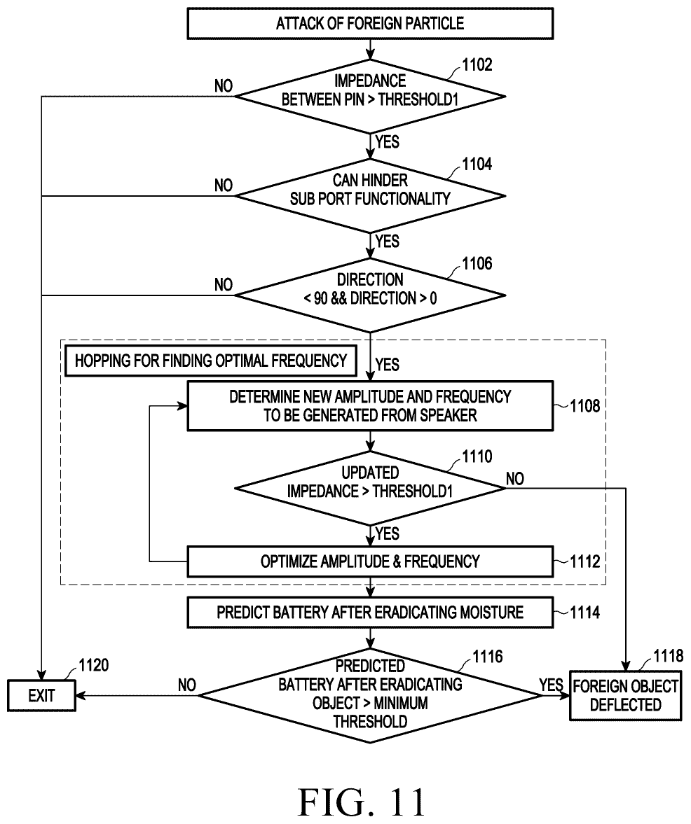

FIG. 11 illustrates a flowchart for an eradication of a foreign object using sound, according to an embodiment of the disclosure.

As depicted, at operation 1102, it may be determined whether the impedance between pins is greater than a predefined threshold value. Further, at operation 1104, it may be determined whether the impedance can hinder the USB port/connector's functionality. At operation 1106, it may be determined whether the direction of movement of the foreign object is greater than zero but less than 90 degrees. Based on a positive determination at operations 1102-1106, the method may include determining an amplitude and frequency to be generated from the speaker of the electronic device at operation 1108. At operation 1110, it may be determined whether the updated impedance is still greater than a predefined threshold value. If yes, at operation 1112, the method may include optimising the amplitude and frequency of the sound to be generated from the speaker of the electronic device. At operation 1114, a battery level after eradication of the foreign object may be predicted. At operation 1116, it may further be determined whether the predicted battery level after eradication of the foreign object is still greater than the minimum threshold. If the battery level is still greater than the minimum threshold, the user interface of the electronic device may be triggered to display that the foreign object has been eliminated at operation 1118. Otherwise, the method moves to exit at operation 1120.

In an embodiment, the frequency and amplitude of the sound may be determined based on regression analysis. For instance, a polynomial regression of degree 2 is trained as explained below:

$$Y = {β}_{0} + {β}_{1} {X}_{i +} {β}_{2} {X}_{j}^{2} + … {β}_{p} {X}_{j}^{p} + ε$$

Where:
β₀=population regression constant
βᵢ=population regression coefficient for variable
p=order of the polynomial
εi=model error
X1=type of foreign particle
X2=impedance
X3=direction of foreign particle
Y=value of the dependent variable (frequency and amplitude) based on the value of at least one independent variable (type of foreign particle, impedance and direction of movement of foreign particle).

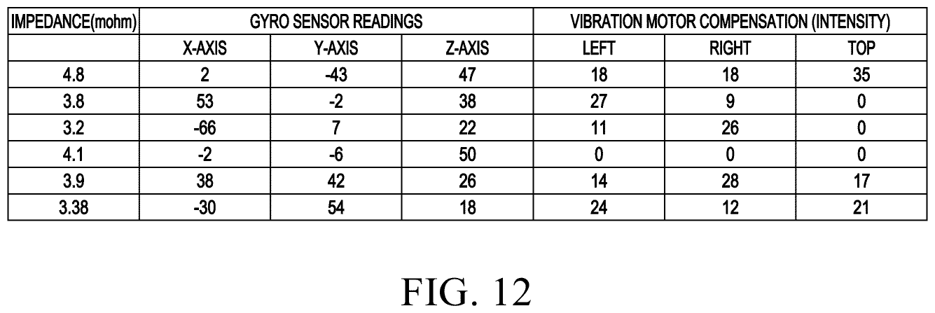

FIG. 12 illustrates a set of vibration motor compensation (intensity) for the electronic device, according to an embodiment of the disclosure.

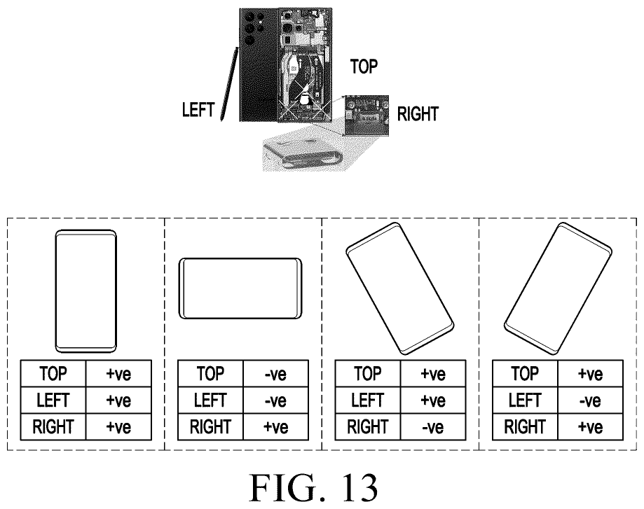

FIG. 13 illustrates a schematic of the vibration intensity on different predefined distances, in accordance with an embodiment of the disclosure.

FIGS. 12 and 13 are explained in conjunction herein below.

Referring to FIG. 12, in an embodiment, the vibration intensity may be determined based on impedance and gyroscope sensor readings associated with the current position of the electronic device. In an embodiment, the vibration intensity may be generated via a vibration motor within a predefined distance from the charging port, to eliminate the foreign object from the charging port.

Referring to FIG. 13, the vibration intensity on different predefined distances may include at least three different positions, such as, but not limited to, top, left, and right from the vibration motor. Further, as depicted in FIG. 13, the impact of vibration at different positions can be both, i.e., positive or negative, which depends upon device orientation, impedance value, and the pin where the foreign object is present.

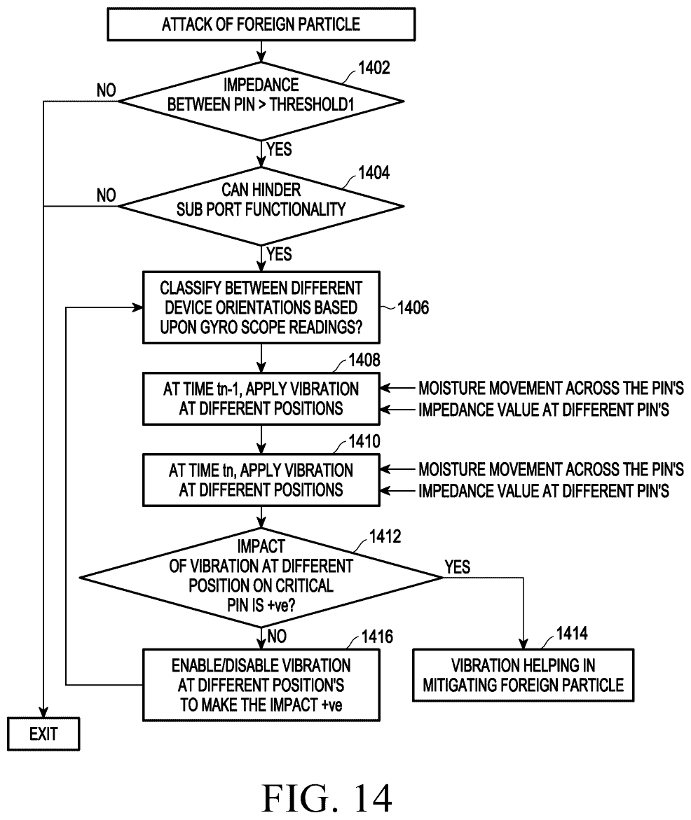

FIG. 14 illustrates a flowchart for the eradication of a foreign object using vibration, according to an embodiment of the disclosure.

As depicted, at operation 1402, it may be determined whether the impedance between pins is greater than a predefined threshold value. Further, at operation 1404, it may be determined whether the impedance can hinder USB port/connector's functionality. Based on a positive determination at operations 1402-1404, the method may include classifying among different device orientations based upon gyroscope readings at operation 1406. Specifically, the classifying may include identifying current position or orientation (e.g., horizontal, vertical, etc.) of the electronic device. At operation 1408, the method may include applying vibration at a specific time (i.e., at tn-1). For the execution of this operation, the movement of a foreign object across the pins along with impedance value at different pins may be received. Similarly, at operation 1410, the method may include applying vibration at a specific subsequent time/timestamp (i.e., at tn). For the execution of this operation, the movement of the foreign object across the pins along with impedance value at different pins may be received. At operation 1412, it may be determined whether the impact of vibration at different positions on critical pins is positive or not, based on re-calculating impedance values. If yes, the method moves to operation 1414 to conclude that the vibration is helping in the eradication of foreign object. If not, the method moves to operation 1416 to enable/disable vibration at different positions to make the impact positive.

In an embodiment, the vibration intensity may be determined using a trained neural network-based model. For instance, based on impedance, pin location where the foreign particle is present, and device orientation being fed into the trained neural network model (specifically, to trained tensor flow keras sequential model), the effective vibration intensity in different directions may be determined can be helpful in mitigating foreign object.

In an embodiment, tensorflow's Keras sequential model may be used with dense layers. The input shape is (5,1) and the output shape is (K,1) where K is the number of features taken. Apart from these, 3 dense layers are also added for getting unidentified features. A model optimizer (e.g., Adam Optimizer) may be used with Sparse Categorical Cross entropy loss and accuracy metrics. Adam is an optimization algorithm used instead of the classical stochastic gradient descent procedure to update network weights iterative based on training data.

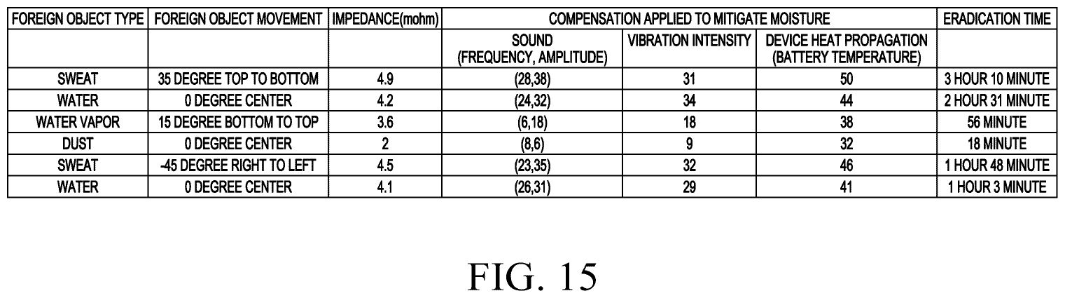

Referring back to FIG. 4, in an embodiment, the eradication meter module 406 is an AI-based module, which can provide a user with intuitive information, i.e., the total time required to eradicate foreign objects using various parameters. More specifically, the eradication time may be determined based on the type of foreign object, the movement of the foreign object, impedance, sound/vibration compensation applied to eradicate the foreign object, current environment condition, and temperature of the battery of the electronic device. A pre-trained neural network may be used to determine the eradication time for the foreign object based on the aforementioned parameters fed into the network as an input. The eradication meter module 406 is further discussed in detail in conjunction with FIG. 15.

FIG. 15 illustrates a sample dataset for a determination of total eradication time required for various foreign objects, via the eradication meter module 406, according to an embodiment of the disclosure.

In an embodiment, where the foreign object is moisture/sweat, the eradication time may refer to evaporation time. Evaporation is a process where liquid/semi-solid particle changes into a gas below the temperature at which it boils. The evaporation property of any particle depends upon entropy (higher entropy means higher evaporation), wherein the entropy is the degree of randomness or disorder in the particle. Gaseous substances have higher kinetic energy and more space available to move in faster, random as compared to liquid/semi-solid. The entropy of different particles is given in decreasing order:
Gas>Water vapor>Sweat>Water>Dust

Further, for the eradication of foreign object, battery temperature plays a key role. Phone batteries are generally Li-ion cells. When more than one CPU core gets activated, then the electronic device gets heated up and this heat can be measured using a battery thermostat. Temperature plays an important role in mitigating USB port moisture as evaporation rates are higher at higher temperatures because as temperature increases, the amount of energy necessary for evaporation decreases. In sunny and warm weather, the loss of water by evaporation is greater than in cloudy and cool weather.

As discussed above, vibration may be introduced to get rid of the foreign object. The vibration refers to the property of a mechanical device (e.g., a motor) that can make the electronic device vibrate when applied to a system or structure that has several points with different amplitudes of deflection. Electronic devices may include a feature of generating custom vibrations with different amplitudes. Evaporation also depends upon surface area of the material. Vibration basically helps in spreading the moisture across the surface which increases the surface area of the foreign object. Thus, the rate of evaporation is directly proportional to the surface area of liquid type foreign object.

In an embodiment, a sequence of values at different time intervals as a vector which includes type of foreign particle, rate of change moisture, battery temperature readings, and effect of different compensations (i.e., sound and vibration) on a foreign object, may be fed to a trained recurrent neural network which predicts estimated time to completely eradicate the foreign object.

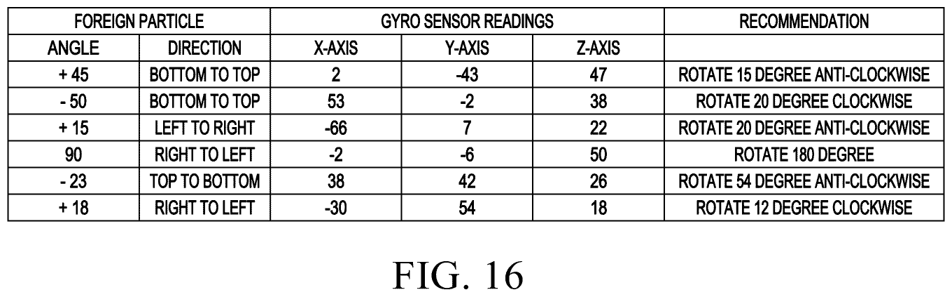

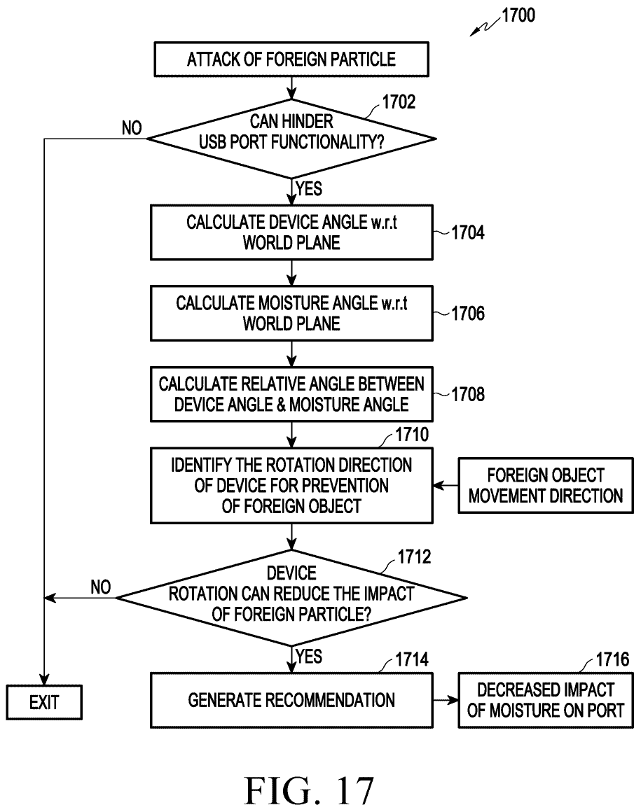

Referring back to FIG. 4, in an embodiment, the recommendation module 408 may be an AI-based module, which can prevent moisture on the connector/USB port by generating a set of recommendations by using various properties associated with the electronic device, port, and the environment. This is further discussed in conjunction with FIGS. 16 and 17.

FIG. 16 illustrates a sample dataset for recommendations to handle foreign objects by a recommendation module, according to an embodiment of the disclosure.

As depicted, one or more recommendations may be determined based on the angle, the direction of movement of a foreign object, and gyroscope sensor readings. Recommendations may include changing at least one of a present positions or orientation of the user device. The recommendations may be provided, via a display interface of the electronic device, to the user to facilitate one of the elimination or prevention of the foreign object.

FIG. 17 illustrates a process flow depicting a method 1700 to provide one or more recommendations by the recommendation module, according to an embodiment of the disclosure.

As depicted, at operation 1702, it may be determined whether the foreign object can hinder the USB port/connector's functionality. Based on a positive determination at operation 1702, the method may include calculating device angle, foreign object angle, a relative angle between the device angle and the foreign object angle at operations 1704, 1706, and 1708 respectively. At operation 1710, the method may include identifying rotation direction of the device for prevention of the foreign object based on direction of movement of the foreign object. At operation 1712, it may be determined whether the device rotation may reduce impact of the foreign object. This determination may be performed using a pre-trained AI model which is based on historical data captured previously for one or more other devices in similar situations. If yes, then a recommendation may be generated at operation 1714, else, the method may move to the end. The impact of the object may be reduced based on the recommendations, as depicted at operation 1716.

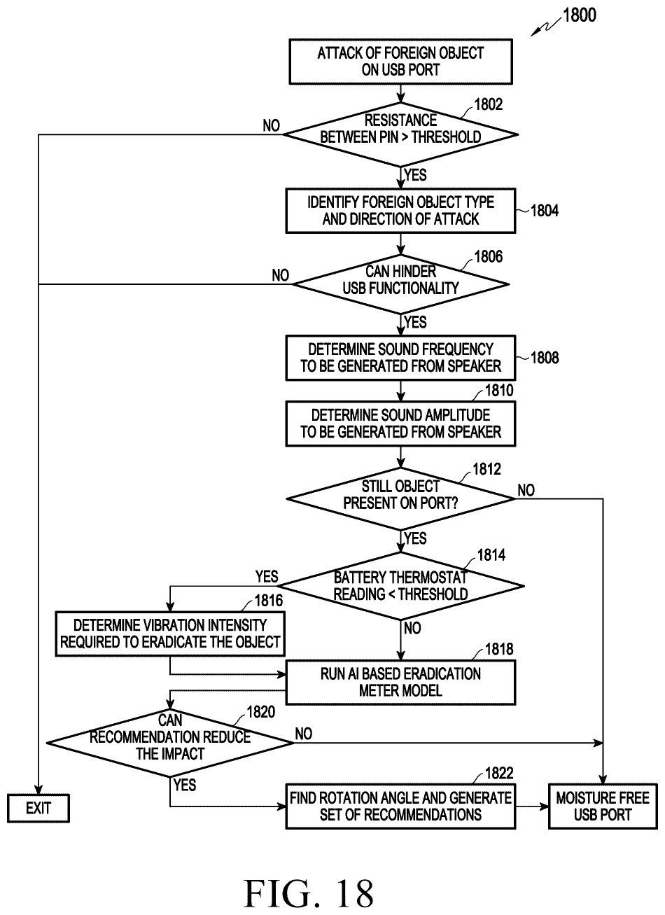

FIG. 18 illustrates a process flow depicting a method 1800 for the handling of the foreign object, according to an embodiment of the disclosure.

As depicted, at operation 1802, it may be determined whether the resistance between the pins is greater than a predefined threshold. This is performed based on a current-resistance analysis at the pins of the charging port. If the resistance is greater than the predefined threshold, the foreign object may be identified along with a direction of movement/attack at operation 1804. Further, at operation 1806, it may also be determined if the foreign object may hinder the functionality of the electronic/user device. Upon determining that functionality may be hindered, a sound frequency and amplitude may be determined which is to be generated from the speaker of the device at operations 1808 and 1810. At operation 1812, it may be determined whether there is still object left in the charging port. In case of object still present, at operation 1814, it may be determined whether the battery thermostat reading is lesser than a predefined threshold. If the battery thermostat reading is less than the threshold, then at operation 1816, a vibration intensity may be determined to eradicate the object. If the battery thermostat is greater than the threshold, then, at operation 1818, the eradication meter module may be triggered to determine an estimated time to eradicate the object. Further, at operation 1820, it may be determined if the recommendations may reduce impact of the object or if the recommendations may expedite the eradication of the object. If yes, then, at operation 1822, one or more recommendations may be generated associated with rotation angle for the user.

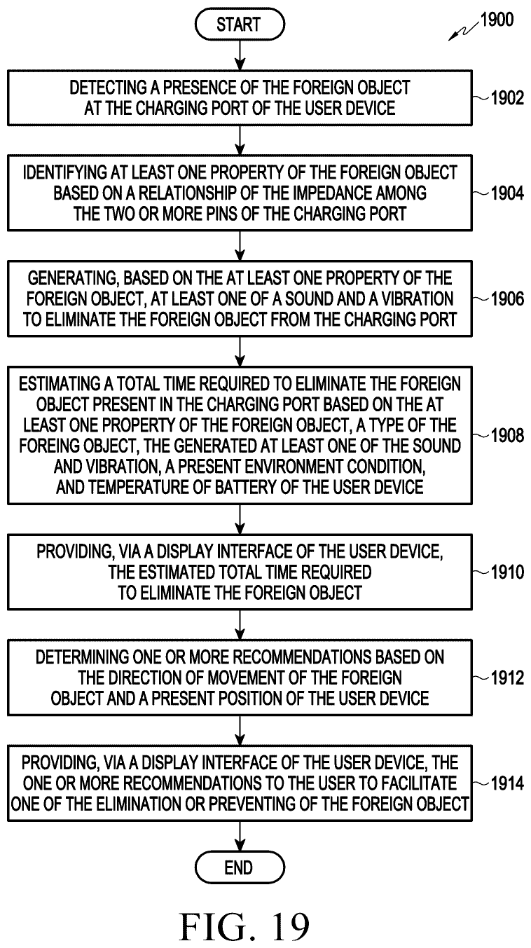

FIG. 19 illustrates another process flow depicting a method 1900 for handling of a foreign object, according to an embodiment of the disclosure.

At operation 1902, the method 1900 comprises detecting a presence of the foreign object at the charging port of the user device. In an embodiment, the presence of the foreign object may be detected based on an impedance among two or more pins of the charging port.

The detection of presence of the foreign object may include determining whether the impedance among the two or more pins of the charging port is greater than a predefined threshold. The presence of the foreign object may then be detected based on a determination that the impedance is greater than the predefined threshold.

At operation 1904, the method 1900 comprises identifying at least one property of the foreign object based on a relationship of the impedance among the two or more pins of the charging port. In an embodiment, the at least one property comprises a type of the foreign object and a direction of movement of the foreign object in the charging port. Further, to identify the type of the foreign object, the identifying may include classifying the type of the detected foreign object based on the relationship of the impedance among the two or more pins, wherein the type of the detected object may include one of a water, sweat, vapour, a gas, and dust particles. Further, the classifying the type of the detected foreign object may include analyzing a rate of change of the impedance among the two or more pins of the charging port.

In an embodiment, identifying the direction of movement of the foreign object in the charging port may comprise determining, at two or more timestamps, another impedance at a plurality of pins of the charging port. Subsequently, a rate of change of the other impedance at each of the plurality of pins may be determined, and at least two pins, among the plurality of pins, may be identified for which the rate of change of the other impedance is greater than a predefined threshold. Finally, an angle between a center of the at least two pins may be computed to identify the direction of movement of the foreign object.

At operation 1906, the method 1900 comprises generating, based on the at least one property of the foreign object, at least one of a sound and a vibration to eliminate the foreign object from the charging port. In one embodiment, generating the at least one of the sound and the vibration to eliminate the foreign object from the charging port may be performed based on the at least one property of the foreign object, a type of the charging port, and a condition of the user device.

In an embodiment, generating the at least one of the sound and vibration may comprise determining, based on the at least one property of the foreign object, a sound frequency, and a sound amplitude for the sound to be generated by a speaker of the user device to eliminate the foreign object from the charging port. The elimination of the foreign object may imply a partial or a complete removal of the foreign object from the inside area of the charging port.

The generation of the vibration may include determining an intensity of the vibration to be generated via a vibration motor within a predefined distance from the charging port, to eliminate the foreign object from the charging port. Once the intensity of the vibration is determined, a trigger signal may be provided to the vibration motor to initiate the process of elimination of the foreign object. Due to the generated vibration (or sound), the foreign object may be displaced from its detected location to outside of the charging port.

In another embodiment, generating the at least one of the sound and vibration comprises determining whether a battery thermostat reading is lesser than a predefined threshold. Further, the at least one of the sound and the vibration may be determined based a determination that the battery thermostat reading is lesser than a predefined threshold.

At operation 1908, the method 1900 comprises estimating a total time required to eliminate the foreign object present in the charging port based on the at least one property of the foreign object, a type of the foreign object, the generated at least one of the sound and vibration, a present environment condition, and temperature of battery of the user device.

At operation 1910, the method 1900 comprises providing, via a display interface of the user device, the estimated total time required to eliminate the foreign object.

At operation 1912, the method 1900 comprises determining one or more recommendations based on the direction of movement of the foreign object and a present position of the user device.

At operation 1914, the method 1900 comprises providing, via a display interface of the user device, the determined one or more recommendations to the user to facilitate one of the elimination or preventing of the foreign object. In one embodiment, the one or more recommendations may comprise at least one of a change in present position or orientation of the user device.

While the operations in above flowcharts or various process flows are shown in a specific manner and described in a particular sequence, the operations may occur in variations to the sequence in accordance with one or more embodiments of the disclosure. Further, since the operations have previously been explained in conjunction with working of each module, these are not discussed in detail again for the sake of brevity.

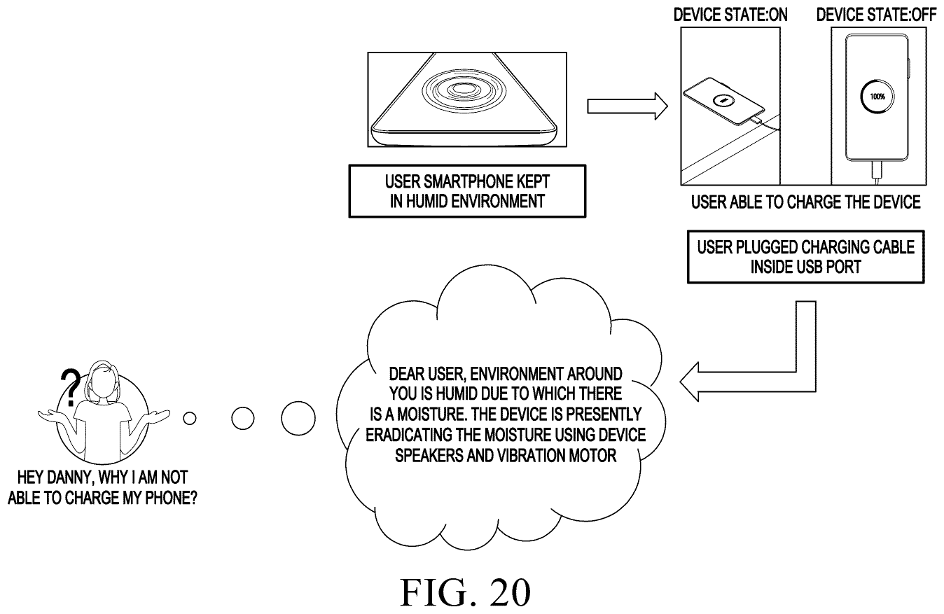

FIGS. 20 to 22 illustrate various use cases for handling of a foreign object, according to various embodiments of the disclosure.

Referring to FIG. 20, as depicted, if there is moisture (i.e., a foreign object) in the charging port of the electronic/user device, the electronic device may detect the presence of foreign object and may also display a recommendation that “Dear User, environment around you is humid due to which there is a moisture. The device is presently eradicating the moisture using device speakers and vibration motor,” thereby providing a real-time detection and status of the device to the user via the display/user interface.

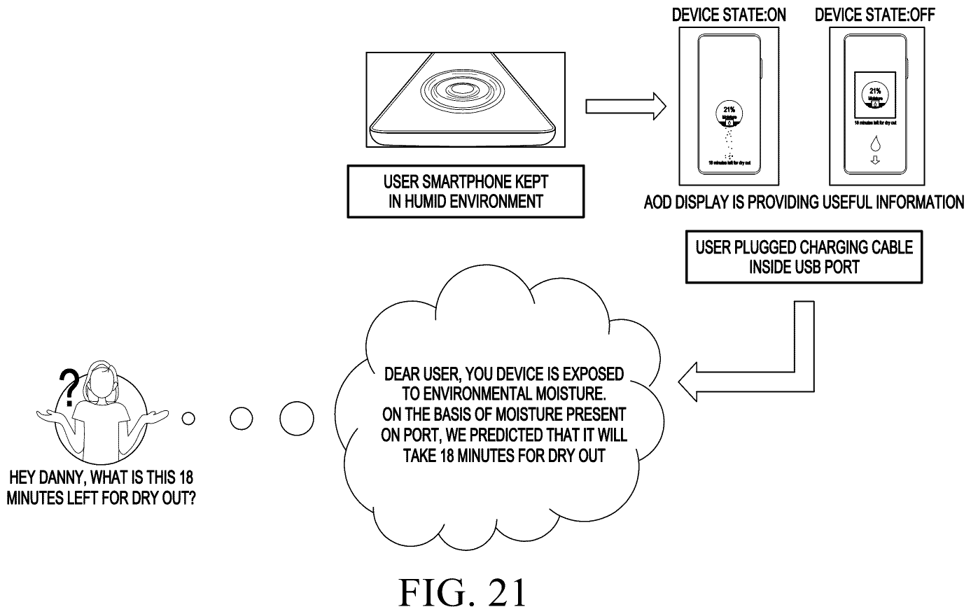

Referring to FIG. 21, as depicted, if there is moisture (i.e., a foreign object) in the charging port of the electronic/user device, the electronic device may detect the presence of foreign object(s) and may also display a recommendation that “Dear User, your device is Exposed to environmental Moisture. On the basis of Moisture present on port, we predicted that it will take 18 minutes for dry out,” thereby providing a real-time timeline for elimination of the foreign object.

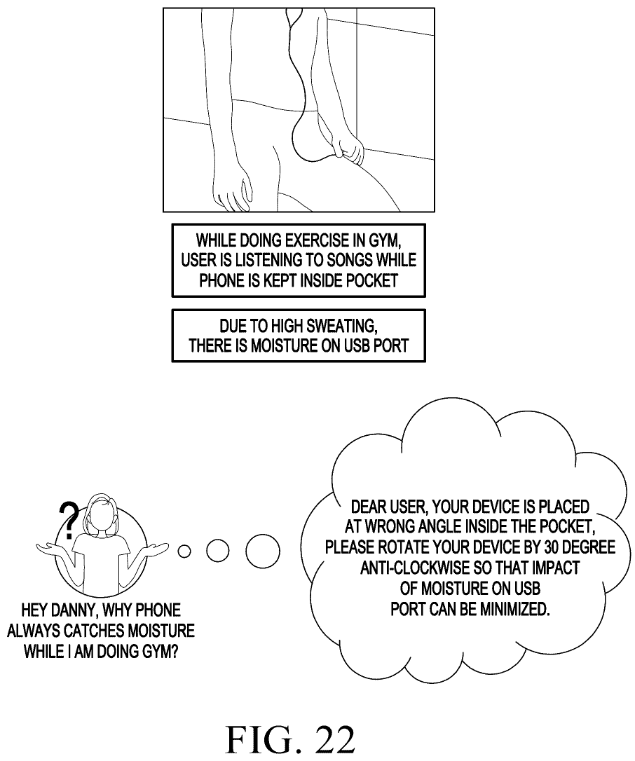

Referring to FIG. 22, as depicted, in the disclosure, the user is provided with a recommendation in case of a foreign object detected in the electronic/user device. As illustrated, the user may be provided a recommendation to place the device at a certain angle so that the impact of sweat/moisture may be minimized during working out in a gym.

The disclosure provides for various technological advancements based on the key features discussed above. Specifically, this disclosure can help in preventing foreign particles on the USB port and intuitively inform the user about the time after which the port will be moisture free. Further, the system can be implemented in all devices that at least support USB C-Type Port (i.e., the most used port in electronic devices). The features of the disclosure reduce the likelihood of hardware damage, short circuit, and device blast due to burning. Warning/alerts may be generated associated with a wet charging port or moisture residuals, dust particles building inside the USB port, or if the charging port has been damaged due to corrosion, frequent contact with humidity/wet/water, or careless usage.

Those skilled in the art will appreciate that one or more of the described elements may well be combined into a single functional element. Alternatively, certain elements may be split into multiple functional elements. Elements from one embodiment may be added to another embodiment.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for handling a foreign object at a charging port of an electronic device, the method comprising:
detecting a presence of the foreign object at the charging port of the electronic device, based on an impedance among two or more pins of the charging port;
identifying at least one property of the foreign object based on a relationship of the impedance among the two or more pins of the charging port, wherein the at least one property comprises at least one of a type of the foreign object and a direction of movement of the foreign object in the charging port; and
generating, based on the at least one property of the foreign object, at least one of a sound and a vibration to eliminate the foreign object from the charging port.

2. The method of claim 1, wherein the generating of the at least one of the sound and the vibration comprises:
determining, based on the at least one property of the foreign object, a sound frequency and a sound amplitude for the sound to be generated by a speaker of the electronic device to eliminate the foreign object from the charging port.

3. The method of claim 1, wherein the generating of the at least one of the sound and the vibration comprises:
determining, based on the at least one property of the foreign object, an intensity of the vibration to be generated via a vibration motor within a predefined distance from the charging port, to eliminate the foreign object from the charging port.

4. The method of claim 1, wherein the detecting of the presence of the foreign object comprises:
determining whether the impedance among the two or more pins of the charging port is greater than a predefined threshold; and
identifying the presence of the foreign object based on a determination that the impedance is greater than the predefined threshold.

5. The method of claim 4,
wherein the identifying of the at least one property of the foreign object comprises:
classifying the type of the identified foreign object based on the relationship of the impedance among the two or more pins, and
wherein the type of the identified foreign object may include one of a water, sweat, vapour, a gas, and dust particles.

6. The method of claim 5, wherein the classifying of the type of the identified foreign object comprises analyzing a rate of change of the impedance among the two or more pins of the charging port.

7. The method of claim 1, further comprising:
generating the at least one of the sound and the vibration to eliminate the foreign object from the charging port based on the at least one property of the foreign object, a type of the charging port, and a condition of the electronic device.

8. The method of claim 1, further comprising:
estimating a total time required to eliminate the foreign object present in the charging port based on the at least one property of the foreign object, the type of the foreign object, the generated at least one of the sound and the vibration, a present environment condition, and temperature of battery of the electronic device; and
providing, via a display interface of the electronic device, the estimated total time required to eliminate the foreign object.

9. The method of claim 1, further comprising:
determining one or more recommendations based on the direction of the movement of the foreign object and a present position of the electronic device.

10. The method of claim 9, further comprising:
providing, via a display interface of the electronic device, one or more recommendations to the electronic device to facilitate one of the elimination or preventing of the foreign object, wherein the one or more recommendations comprises at least one of a change in the present position or orientation of the electronic device.

11. The method of claim 1, wherein the generating of the at least one of the sound and the vibration comprises:
determining whether a battery thermostat reading is lesser than a predefined threshold; and
determining the at least one of the sound and the vibration based a determination that the battery thermostat reading is lesser than the predefined threshold.

12. The method of claim 1, wherein the identifying of the direction of the movement of the foreign object in the charging port comprises:
determining, at two or more timestamps, another impedance at a plurality of pins of the charging port;
determining a rate of change of the other impedance at each of the plurality of pins;
identifying at least two pins, among the plurality of pins, for which the rate of the change of the other impedance is greater than a predefined threshold; and
computing an angle between a center of the at least two pins to identify the direction of the movement of the foreign object.

13. An electronic device for handling a foreign object at a charging port of the electronic device, the electronic device comprising:
memory storing one or more computer programs; and
one or more processors communicatively coupled to the memory,
wherein the one or more computer programs include computer-executable instructions that, when executed by the one or more processors individually or collectively, cause the electronic device to:
detect a presence of the foreign object at the charging port of the electronic device, based on an impedance among two or more pins of the charging port,
identify at least one property of the foreign object based on a relationship of the impedance among the two or more pins of the charging port, wherein the at least one property comprises at least one of a type of the foreign object and a direction of movement of the foreign object in the charging port, and
generate, based on the at least one property of the foreign object, at least one of a sound and a vibration to eliminate the foreign object from the charging port.

14. The electronic device of claim 13, wherein the one or more computer programs further include computer-executable instructions that, when executed by the one or more processors individually or collectively, cause the electronic device to:
determine, based on the at least one property of the foreign object, a sound frequency and a sound amplitude for the sound to be generated by a speaker of the electronic device to eliminate the foreign object from the charging port.

15. The electronic device of claim 13, wherein the one or more computer programs further include computer-executable instructions that, when executed by the one or more processors individually or collectively, cause the electronic device to:
determine, based on the at least one property of the foreign object, an intensity of the vibration to be generated via a vibration motor within a predefined distance from the charging port, to eliminate the foreign object from the charging port.

16. The electronic device of claim 13, wherein the one or more computer programs further include computer-executable instructions that, when executed by the one or more processors individually or collectively, cause the electronic device to:
determine whether the impedance among the two or more pins of the charging port is greater than a predefined threshold, and
identify the presence of the foreign object based on a determination that the impedance is greater than the predefined threshold.

17. The electronic device of claim 16,
wherein the one or more computer programs further include computer-executable instructions that, when executed by the one or more processors individually or collectively, cause the electronic device to:
classify the type of the identified foreign object based on the relationship of the impedance among the two or more pins, and
wherein the type of the identified foreign object may include one of a water, sweat, vapour, a gas, and dust particles.

18. The electronic device of claim 17, wherein the classification of the type of the identified foreign object comprises analyzing a rate of change of the impedance among the two or more pins of the charging port.

19. One or more non-transitory computer-readable storage media storing one or more computer programs including computer-executable instructions that, when executed by one or more processors of an electronic device individually or collectively, cause the electronic device to perform operations, the operations comprising:
detecting a presence of a foreign object at a charging port of the electronic device, based on an impedance among two or more pins of the charging port;
identifying at least one property of the foreign object based on a relationship of the impedance among the two or more pins of the charging port, wherein the at least one property comprises at least one of a type of the foreign object and a direction of movement of the foreign object in the charging port; and
generating, based on the at least one property of the foreign object, at least one of a sound and a vibration to eliminate the foreign object from the charging port.

20. The one or more non-transitory computer-readable storage media of claim 19, the operations further comprising:
determining, based on the at least one property of the foreign object, a sound frequency and a sound amplitude for the sound to be generated by a speaker of the electronic device to eliminate the foreign object from the charging port.
